(19) United States
(12) Patent Application Publication
(10) Pub. No.: US 2016/0134744 A1
(43) Pub. Date: May 12, 2016

(54) Apparatus and method to prevent distraction from a mobile device while driving when that device is determined to be within a restricted zone inside the vehicle

(71) Applicant: Alfonso Fabian de la Fuente Sanchez, Saanich (CA)

(72) Inventor: Alfonso Fabian de la Fuente Sanchez, Saanich (CA)

(21) Appl. No.: 14/537,325

(22) Filed: Nov. 10, 2014

(51) Int. Cl. H04M 1/725; H04W 4/02; H04W 4/00

(52) U.S. Cl. CPC H04M 1/72577; H04W 4/008; H04W 4/02

(57) ABSTRACT

A method and apparatus for controlling the operability of a mobile device while that mobile device is inside a vehicle equipped with a concealed NFC transmitter located inside the vehicle's cigarette lighter DC connector that transmits a signal, which is directed by deflection to ideally cover the driver's seat area. When that signal is received and decoded by nearby mobile devices using specific software, a process that begins by determining whether such mobile device is located within the vehicle and proximate to the driver's seat gets started, then, the system defines the transmitted signal coverage area as a restricted zone in which the mobile device use is partially or fully prohibited. The area where the radio signal is weaker or null is identified as a safe zone in which all or some of the functionality of the mobile devices is enabled. Once it's determined that a mobile device is within a restricted zone, a determination is made as to whether any usage prohibition conditions are satisfied. If usage prohibition conditions are satisfied, then particular functions of the mobile device may be disabled or overridden in a restricted zone. If prohibition conditions are not met, the mobile device may be totally enabled, partially enabled to allow certain functions, or the mobile device is never disabled. If any of the passenger's mobile devices are present and within the restricted zone range, they can override the prohibition by selecting who's their driver and systematically blocking the driver's mobile device.

Apparatus and method to prevent distraction from a mobile device while driving when the position of said device is determined to be within a restricted zone inside the vehicle.

### FIELD

The present invention relates to mobile devices and vehicle accessories. In particular, the present invention relates to disabling voice and text communication on a mobile device while inside a vehicle when restriction conditions are met.

### BACKGROUND

Mobile communication devices are distracting drivers while they drive and this is the cause of many teenager accidents in the road.

New vehicles have Bluetooth pairing allowing such mobile devices to answer hands free phone calls and somehow managing texts and email messaging. In such cases, the control of the mobile device is taken by the car's entertainment system. The Bluetooth signal works when the mobile device is near or inside the vehicle and most in-vehicle entertainment systems only allow one mobile device at a time to be paired with them. That becomes a problem, as it may not be the driver's mobile device the one that is paired automatically by the car's entertainment system but maybe the passenger's mobile device, leaving the driver's mobile device un-paired and if a call comes in, if he chooses to answer it, he will need to use his hands to answer compromising his driving abilities and distracting him/her from the road.

More recently other Bluetooth devices that connect to the OBD-II interface found in newer vehicles emulate the Bluetooth pairing and with the combination of using it with special software running in the driver's mobile device the blocking is performed. The problem with this technology is that the blocking area is set to anywhere where the Bluetooth signal is spread inside the vehicle and not only to the place where the driver's seat is.

Other devices using RFID and NFC technology let the mobile device take care of the task of sending all phone calls to hands free answering or sending the phone calls to voice mail while the mobile device is paired with the NFC label or RFID signal. The inconvenience of this approach is that the mobile device needs to “touch” the NFC label as the range field of regular passive NFC labels is very short to identify that the device is inside a vehicle, if the driver chooses not to touch the NFC label with his/her mobile device, the blocking is not enabled.

Other methods using RFID is when the mobile device needs to identify the RFID signal which is very strong and covers more than just the inside of the vehicle. Built-in NFC is most common for mobile devices than built-in RFID. NFC is also a newer technology than RFID. One more disadvantage of passive NFC label reading is that the device may touch the NFC label to read it so the device is blocked, but when the driver steps out of the vehicle, he/she manually need to alert the mobile device that the device is outside the vehicle, leaving open gaps for driver's to trick the system and override the blocking, then allowing them to text and call while driving.

The apparatus and method of my invention uses software running in the mobile device and a simple and easy to install and use active NFC technology installed in the vehicle. Instead of using a passive NFC label, it uses an antenna wired transponder label attached to a concealed cigarette lighter adapter that can be connected and can stay permanently inside the vehicle's cigarette lighter adapter DC connector. The device of my invention has a three-dimensional 360 degrees rotational antenna deflector with a variable potentiometer, which allows the driver to customize the area where the phone may be stored or carried while the driver is operating the vehicle.

Only a single device is needed per vehicle for the system to work. There is no signal triangulation to detect the position of the driver's mobile device.

The purpose of this invention is that a driver or his/her parent installs the NFC cigarette lighter adapter device inside the vehicle's cigarette lighter DC connector and adjusts the power and direction of the airwaves produced by the device. The NFC cigarette lighter adapter device has a unique NFC ID number that can be paired with the driver's mobile phone using our software or any other similar third party software available in the market. By pairing the NFC cigarette lighter adapter device with the driver's mobile device and configuring the software, the driver instructs the mobile device how to handle incoming phone calls, text and email messages when the driver's mobile device is inside the vehicle within the pre-programmed parameters inside the vehicle.

Similar Bluetooth devices need pairing of the mobile device with the vehicle entertainment system or to a box that can convert the wireless data into analog audio signals so the mobile device's hands free communication can be possible. As this is a two-way communication the device inside the vehicle needs to be a transceiver.

With the device of this invention, the mobile device itself takes all the control and manages the possibilities, the NFC label only acts inside the vehicle as a signal to the mobile device to alert it is within a restricted zone as the signal from the NFC label transmitted is a one-way communication. The device of this invention only acts as means for the mobile device to know that it is inside the vehicle and it should switch to the predetermined mode, in most cases: “driving mode”.

The device of this invention uses the DC connector in vehicles often known as Cigarette Lighter Receptacle as a power source and as a housing installation place within the vehicle.

An important key feature is that the driver does not attempt to remove the device from the Cigarette Lighter Receptacle at will, as when the device is removed it will loose power, and not be able to perform its function of sending a signal to the mobile device.

In order to prevent unwanted removal of the device, the NFC label cigarette lighter adapter transmitter was designed to go deep inside the DC connector receptacle and no part of it outstands from the receptacle. The driver's fingers are prevented from pulling the device out the receptacle because the device does not have anything to pull it from. The receptacle diameter specifications are smaller than 21 mm.

If the owner of the vehicle wants to remove the device from the receptacle or disconnect the device from the power source, such person needs to use tools comparable to a screwdriver to unscrew the potentiometers' screw half way out, then using pliers pull the potentiometers' screw which will then pull the device itself outside the receptacle. If the device needs to be reused, once the device is re-installed and its inside the DC connector receptacle it will need to be re-adjusted as the potentiometer screw was rotated half way out to take it out.

Current micro location solutions within the vehicle relay on installing multiple transponders inside the vehicle. This invention relies in the fact that it only needs the installation of a NFC label cigarette lighter adapter transmitter, the adjustment of a reflective antenna and the configuration of the software running in the driver's mobile device.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side view of the NFC label Cigarette Lighter Adapter transmitter.

FIG. 2 is a side perspective view of the NFC label Cigarette Lighter Adapter transmitter.

FIG. 3A is a frontal view of the NFC label Cigarette Lighter Adapter transmitter.

FIG. 3B is a back view of the NFC label Cigarette Lighter Adapter transmitter.

FIG. 4A is a side perspective view of the NFC label Cigarette Lighter Adapter transmitter with the potentiometer screw half way out.

FIG. 4B is a side view of the NFC label Cigarette Lighter Adapter transmitter with the potentiometer screw half way out.

FIG. 4C is a side perspective view of the NFC label Cigarette Lighter

Adapter transmitter with the potentiometer screw fully unscrewed almost out.

FIG. 4D is a side view of the NFC label Cigarette Lighter Adapter transmitter with the potentiometer screw fully unscrewed almost out.

FIG. 5A is a side cross-sectional view of the NFC label Cigarette Lighter Adapter transmitter with the potentiometer screw screwed all the way in.

FIG. 5B is a side cross-sectional view of the NFC label Cigarette Lighter Adapter transmitter with the screw halfway out.

FIG. 6A is a side cross-sectional view of the NFC label Cigarette Lighter Adapter transmitter with the screw almost all the way out showing how a set of pliers can help take the NFC label Cigarette Lighter

Adapter transmitter comes out of the vehicle's cigarette lighter DC connector tube when the NFC label Cigarette Lighter Adapter transmitter is fully inside the tube.

FIG. 6B is a side cross-sectional view of the NFC label Cigarette Lighter Adapter transmitter with the screw almost all the way out installed inside the DC connector of a vehicle and showing how using a set of pliers can help take the Cigarette Lighter Adapter out.

FIG. 6C is a side cross-sectional view of the NFC label Cigarette Lighter Adapter transmitter with the screw almost all the way out installed inside the DC connector of a vehicle and showing how using a set of pliers can help take the Cigarette Lighter Adapter out.

FIG. 7A is a side perspective view of the Protractible Adjustable Signal Deflector Cap and the way it installs into the vehicle's cigarette lighter DC connector.

FIG. 7B is a back view of the Protractible Adjustable Signal Deflector Cap with the signal deflector semi closed in the back.

FIG. 7C is a back view of the Protractible Adjustable Signal Deflector Cap with the signal deflector fully open.

FIG. 7D is a side view of the Protractible Adjustable Signal Deflector Cap with the signal deflector fully open shown with the protractible option compressed.

FIG. 7E is a side view of the Protractible Adjustable Signal Deflector Cap with the signal deflector fully open shown with the protractible option expanded.

FIG. 7F is a side view of the Protractible Adjustable Signal Deflector Cap with the signal deflector fully open.

REVISAR LOS SIGIENTES 4

FIG. 7G is a side cross-sectional view of the NFC label Cigarette Lighter Adapter transmitter fully installed inside the vehicle's cigarette lighter DC connector tube and showing the way the Protractible Adjustable Signal Deflector Cap installs.

FIG. 7G is a side cross sectional view of the NFC label Cigarette Lighter Adapter transmitter fully installed inside the vehicle's cigarette lighter DC connector tube showing how an adjustable signal deflector cap is inserted into the vehicle's cigarette lighter DC connector tube.

FIG. 7H is a side cross sectional view of the NFC label Cigarette Lighter Adapter transmitter fully installed inside the vehicle's cigarette lighter DC connector tube showing how the protractible adjustable signal deflector cap is inserted into the vehicle's cigarette lighter DC connector tube.

FIG. 7I is a side cross sectional view of the NFC label Cigarette Lighter Adapter transmitter fully installed inside the vehicle's cigarette lighter DC connector tube working in conjunction with the protractible adjustable signal deflector cap used in conjunction with a secondary piggybacked standard cigarette lighter adaptor.

FIG. 7J is a side cross sectional view of the NFC label Cigarette Lighter Adapter transmitter inside the vehicle's cigarette lighter DC connector tube working in conjunction with the protractible adjustable signal deflector cap shown working in conjunction with a secondary piggyback standard cigarette lighter adapter demonstrating how the protractible section helps the contact of the negative poles of the secondary cigarette lighter adapter with the negative charge inside of the toroids.

FIG. 8A Front view of the NFC label Cigarette Lighter Adapter transmitter with the adjustable signal deflector rotated 0 degrees in relation with being completely vertical when the deflector is facing the driver's seat. The signal deflector open at 90%.

FIG. 8B Front view of the NFC label Cigarette Lighter Adapter transmitter with the adjustable signal deflector rotated −90 degrees in relation with being completely vertical when the deflector is facing the driver's seat. The signal deflector open at 75%.

FIG. 8C Front view of the NFC label Cigarette Lighter Adapter transmitter with the adjustable signal deflector rotated −45 degrees in relation with being completely vertical when the deflector is facing the driver's seat. The signal deflector open at 100%.

FIG. 8D Front view of the NFC label Cigarette Lighter Adapter transmitter with the adjustable signal deflector rotated 0 degrees in relation with being completely vertical when the deflector is facing the driver's seat. The signal deflector open at 20%.

FIG. 8E Front view of the NFC label Cigarette Lighter Adapter transmitter with the adjustable signal deflector rotated 90 degrees in relation with being completely vertical when the deflector is facing the driver's seat. The signal deflector open at 50%.

FIG. 8F Front view of the NFC label Cigarette Lighter Adapter transmitter with the adjustable signal deflector rotated 0 degrees in relation with being completely vertical when the deflector is facing the driver's seat. The signal deflector open at 100%.

FIG. 9 is a front view of the vehicle's front dashboard viewed from the inside of the vehicle with the NFC label Cigarette Lighter Adapter transmitter installed.

FIG. 10-A is a front view of the vehicle's dashboard with the NFC label Cigarette Lighter Adapter transmitter and the Protractible Adjustable Signal Deflector Cap installed inside the vehicle's cigarette lighter connector showing a strong NFC type radio signal covering a large area inside the vehicle.

FIG. 10-B is a front view of the vehicle's dashboard with the NFC label Cigarette Lighter Adapter transmitter and the Protractible Adjustable Signal Deflector Cap installed inside the vehicle's cigarette lighter connector showing a regular strength NFC type radio signal covering a regular area inside the vehicle.

FIG. 10-C is a front view of the vehicle's dashboard with the NFC label Cigarette Lighter Adapter transmitter and the Protractible Adjustable Signal Deflector Cap installed inside the vehicle's cigarette lighter connector showing a low power NFC type radio signal covering a small area inside the vehicle.

FIG. 11 is a top view of the vehicle with a NFC label Cigarette Lighter Adapter transmitter and the Protractible Adjustable Signal Deflector Cap installed inside the dashboard's cigarette lighter connector showing a strong NFC type radio signal covering a large area inside the vehicle.

FIG. 12 is a frontal view of the vehicle with a NFC label Cigarette Lighter Adapter transmitter and the Protractible Adjustable Signal Deflector Cap installed inside the dashboard's cigarette lighter connector showing a strong NFC type radio signal covering a large area inside the vehicle.

FIG. 13 is a side view of the vehicle with a NFC label Cigarette Lighter Adapter transmitter and the Protractible Adjustable Signal Deflector Cap installed inside the dashboard's cigarette lighter connector showing a strong NFC type radio signal covering a large area inside the vehicle.

FIG. 14 is a top view of the vehicle with a NFC label Cigarette Lighter Adapter transmitter and the Protractible Adjustable Signal Deflector Cap installed inside the dashboard's cigarette lighter DC connector showing a regular strength NFC type radio signal covering a regular area inside the vehicle.

FIG. 15 is a frontal view of the vehicle with a NFC label Cigarette Lighter Adapter transmitter and the Protractible Adjustable Signal Deflector Cap installed inside the dashboard's cigarette lighter connector showing a regular strength NFC type radio signal covering a regular area inside the vehicle.

FIG. 16 is a side view of the vehicle with a NFC label Cigarette Lighter Adapter transmitter and the Protractible Adjustable Signal Deflector

Cap installed inside the dashboard's cigarette lighter connector showing a regular strength NFC type radio signal covering a regular area inside the vehicle.

FIG. 17 is a top view of the vehicle with a NFC label Cigarette Lighter Adapter transmitter and the Protractible Adjustable Signal Deflector Cap installed inside the dashboard's cigarette lighter connector showing a low power NFC type radio signal covering a small area inside the vehicle.

FIG. 18 is a frontal view of the vehicle with a NFC label Cigarette Lighter Adapter transmitter and the Protractible Adjustable Signal Deflector Cap installed inside the dashboard's cigarette lighter connector showing a low power NFC type radio signal covering a small area inside the vehicle.

FIG. 19 is a side view of the vehicle with a NFC label Cigarette Lighter Adapter transmitter and the Protractible Adjustable Signal Deflector Cap installed inside the dashboard's cigarette lighter connector showing a low power NFC type radio signal covering a small area inside the vehicle.

FIG. 20 is a top view of the vehicle with a NFC label Cigarette Lighter Adapter transmitter and the Protractible Adjustable Signal Deflector Cap installed inside the dashboard's cigarette lighter connector showing an NFC type radio signal covering an area inside the vehicle forming an elliptical wave pointing towards the driver's seat.

FIG. 21 is a front view of the vehicle with a NFC label Cigarette Lighter Adapter transmitter and the Protractible Adjustable Signal Deflector Cap installed inside the dashboard's cigarette lighter connector showing an NFC type radio signal covering an area inside the vehicle forming an elliptical wave pointing towards the driver's seat.

FIG. 22 is a side view of the vehicle with a NFC label Cigarette Lighter Adapter transmitter and the Protractible Adjustable Signal Deflector Cap installed inside the dashboard's cigarette lighter connector showing limited NFC type radio signal covering only the front area inside the vehicle forming an elliptical wave pointing towards the driver's seat.

FIG. 23 is a front view of the vehicle with a NFC label Cigarette Lighter Adapter transmitter and the Protractible Adjustable Signal Deflector Cap installed inside the dashboard's cigarette lighter connector showing an NFC type radio signal covering an area inside the vehicle forming an elliptical wave pointing towards the driver's seat.

FIG. 24 is a top view of the vehicle with the NFC label Cigarette Lighter Adapter transmitter and the Protractible Adjustable Signal Deflector Cap installed inside the dashboard's cigarette lighter DC connector showing an NFC type radio signal covering an area inside the vehicle forming an elliptical wave pointing towards the driver's seat creating what we call a restricted zone where the driver's mobile device such as a cell phone or tablet equipped with a NFC transceiver and running a compatible software, itself detects the mobile device is inside a restricted zone, thus sending the mobile device to driving mode blocking it to receive or make voice calls or text messages while the passengers' devices are in an unrestricted area of the vehicle thus their mobile devices do not detect a NFC signal and even if the mobile devices are running a compatible software, it does not block the passengers' devices from making or receiving voice calls or text messages.

FIG. 25 is a top view of the vehicle with the NFC label cigarette lighter adapter transmitter and the protractible adjustable signal deflector cap installed inside the dashboard's cigarette lighter DC connector, inside the vehicle the driver's mobile device and passengers' mobile device's receiving the NFL label signal.

FIG. 28 is a flow chart describing the method that blocks the driver's mobile device when it is within the covering area of the signal emitted by the NFC transmitter cigarette lighter adaptor.

FIG. 29 is a flow chart continuation describing the method that blocks the driver's mobile device when it is within the covering area of the signal emitted by the NFC transmitter cigarette lighter adaptor.

### DETAILED DESCRIPTION

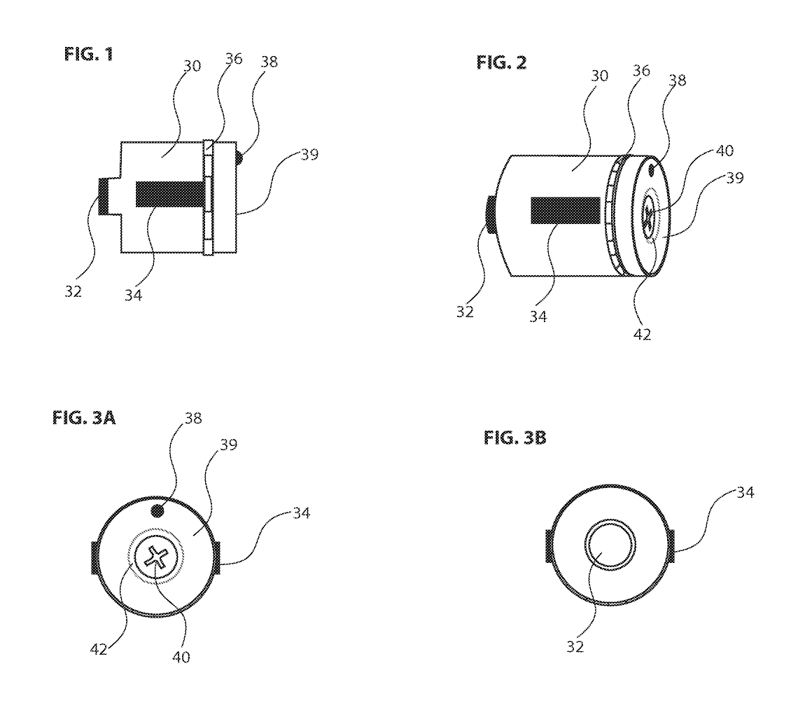

An NFC label Cigarette Lighter Adapter transmitter generally identified by reference numeral (1) will now be described with reference to FIG. 1 through 5.

### Structure and Relationship of Parts

Referring to FIGS. 1, 2, 3A and 3B; The NFC label Cigarette Lighter Adapter transmitter is encased in a cylindrical body named the Cigarette Lighter Adapter body (30) that fits inside a Cigarette Lighter DC connector commonly found in vehicles, which commonly provides an electrical charge of 12 VDC from the vehicle's battery and/or alternator. The cylindrical body (30) that on the front end has an antenna cover (39) and a LED light (38) that lights when the unit receives power to alert the user the unit is working properly. On the opposite face, the back end, there's a positive connector pin (32) that draws positive charge from the Cigarette Lighter DC connector's positive connector. On both sides of the cylindrical shape body (30) there's a pair of negative connectors (34) that also work as spring tensors to create tension between the Cigarette Lighter DC connector inner tube with negative charge and the cigarette lighter adapter body of this invention. The cylindrical body (30) also has a tension band (36) surrounding the circumference of the cylinder made of a material similar to rubber that reduces the amount of slip when the cylinder is inside the inner tube of the vehicle's cigarette lighter DC connector.

On the front end of the cylindrical body there's a counter sunk hole (42) that hosts a counter sink screw (40), which is hot with DC electrical current drawn from the positive connector pin (32) fed by an internal wire.

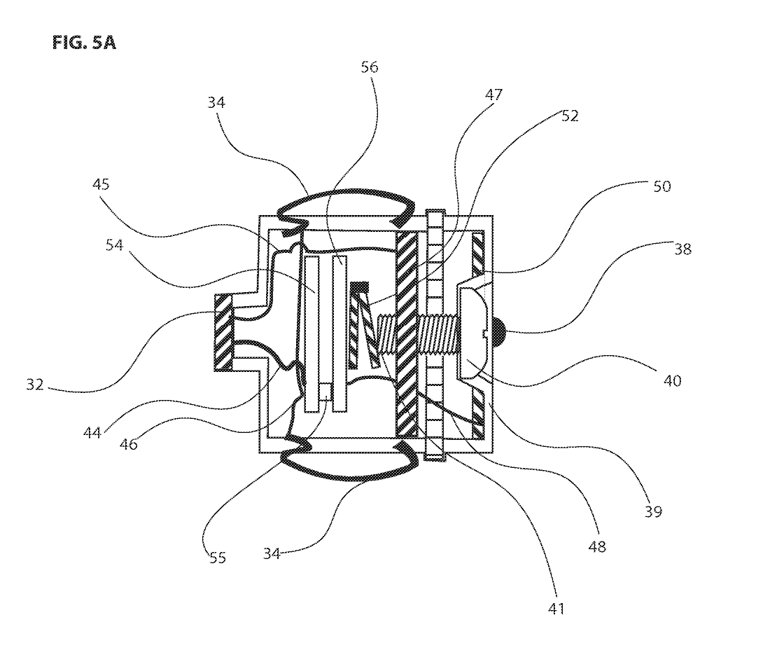

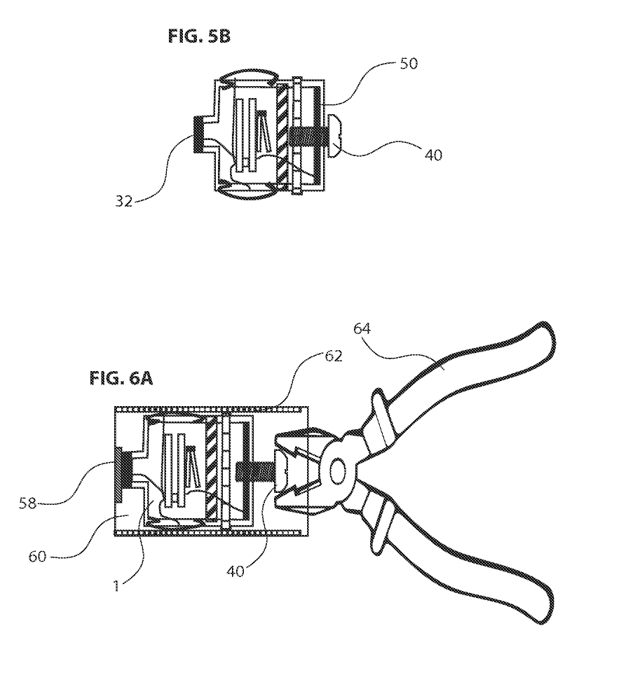

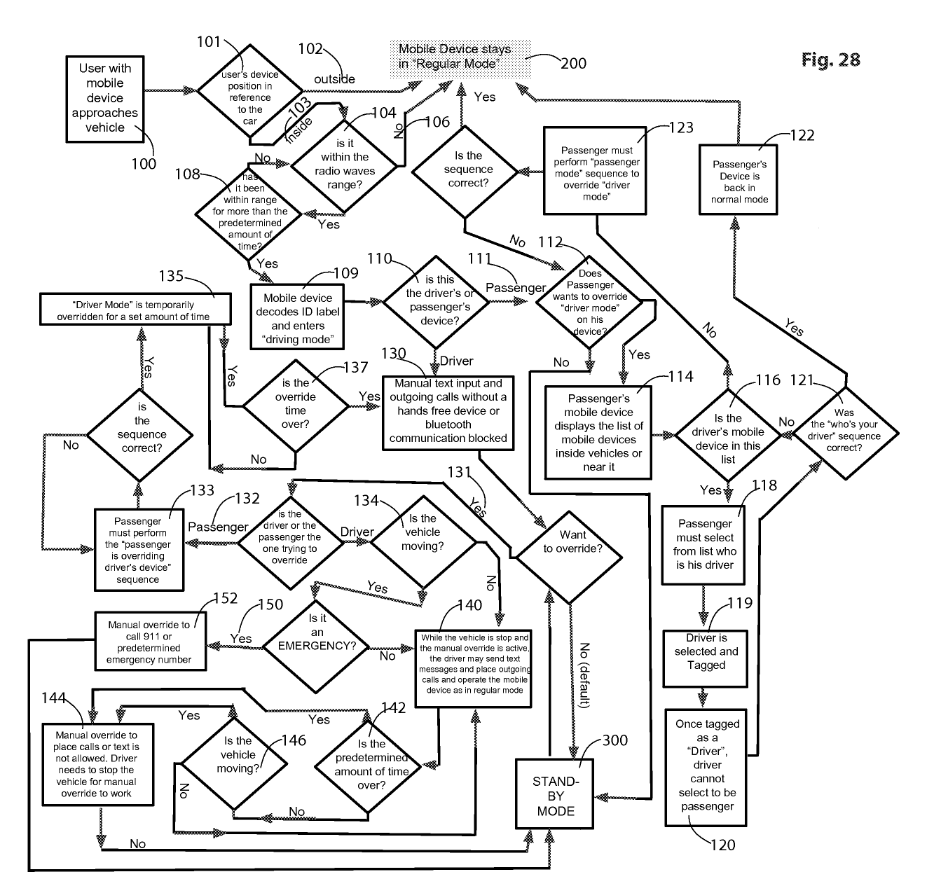

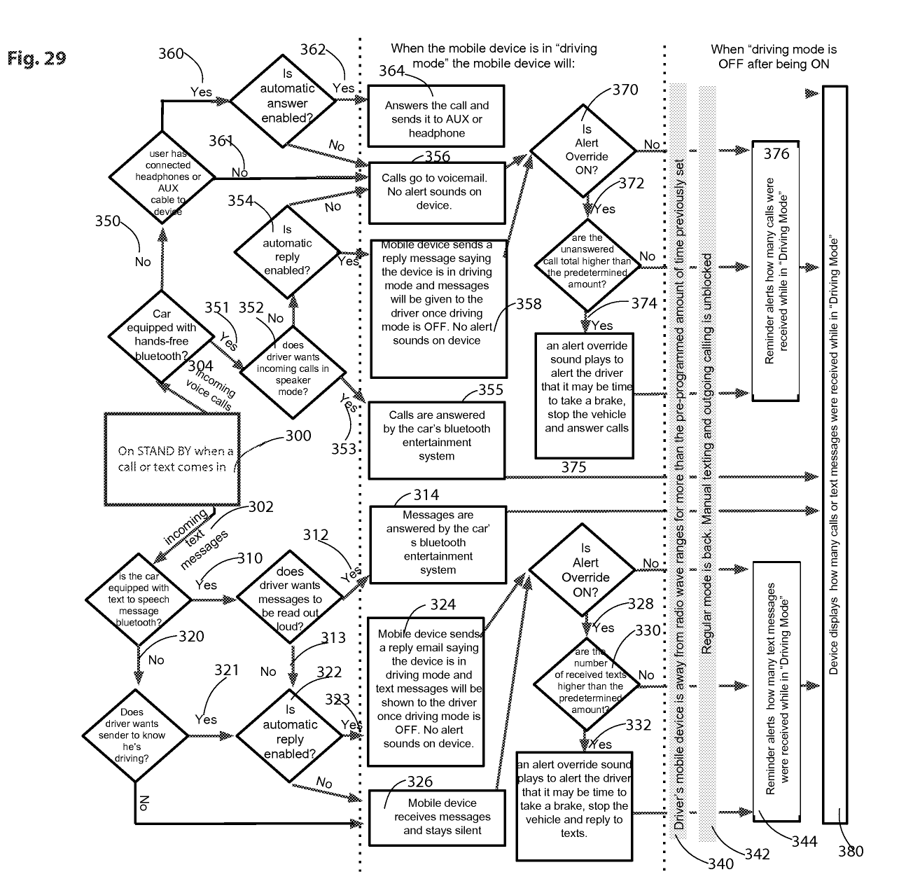

Referring to FIG. 5A, a positive connector pin (32) draws 12 DC electrical current from the vehicle's cigarette lighter DC connector positive pin, the 12 VDC travel via the positive cable (44) to the transformer PCB (54) which also gets the negative charge from the connection between the cylindrical body negative connectors (34) when in contact with the negative charge inner tubing of the vehicle's cigarette lighter DC connector. The negative charge travels via the negative cable (46) to the transformer PCB (54), the transformer converts, regulates and carries via the connector (55) the 12 VDC current to the 5 VDC needed by the NFC transmitter (56) to work. The NFC transmitter (56) transmit a radio wave frequency in the 12 to 14 MHz range via the transmitter cable (48) connected to a fixed antenna (50) located inside the antenna cover (39). The transmitted radio wave frequency carries a NFC or Near Field Communications radio label or number which serves as identification to other devices equipped with near field communication capabilities to know they are in close proximity with a NFC label or transmitter. Such mobile devices may decode the NFC label or ID and if there's a match with instructions on the mobile device's software to act, the mobile device's software may run specific tasks on that mobile device. In the case of this invention, when the mobile device is near the NFC radio signal, the mobile device will act as described in the flowchart of FIGS. 28 and 29.

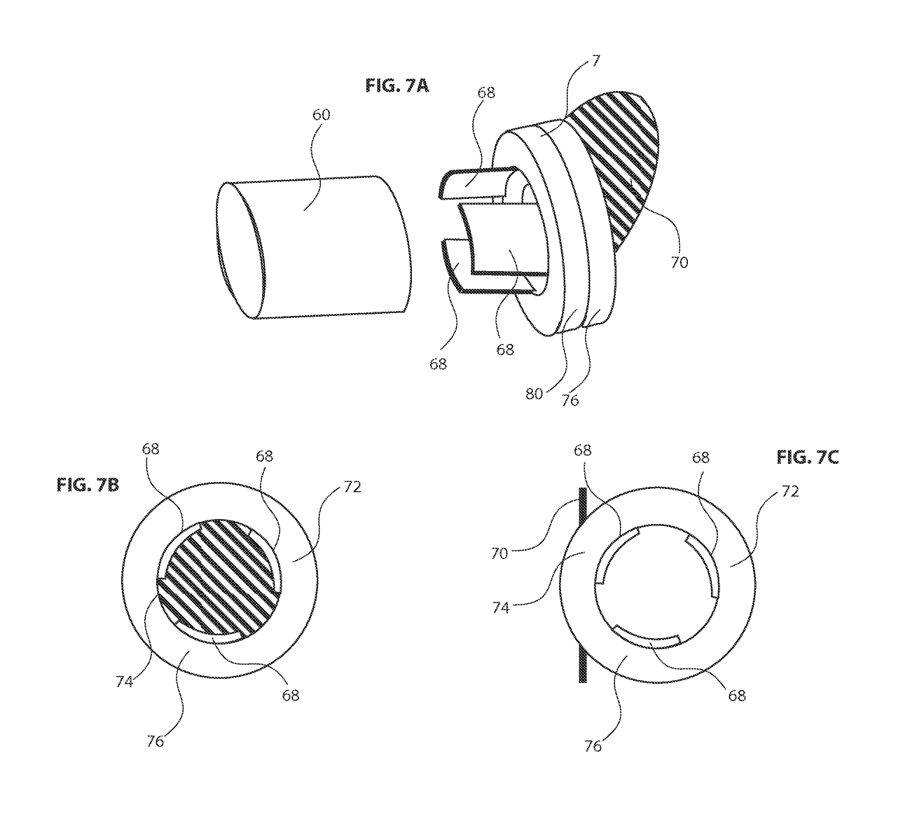

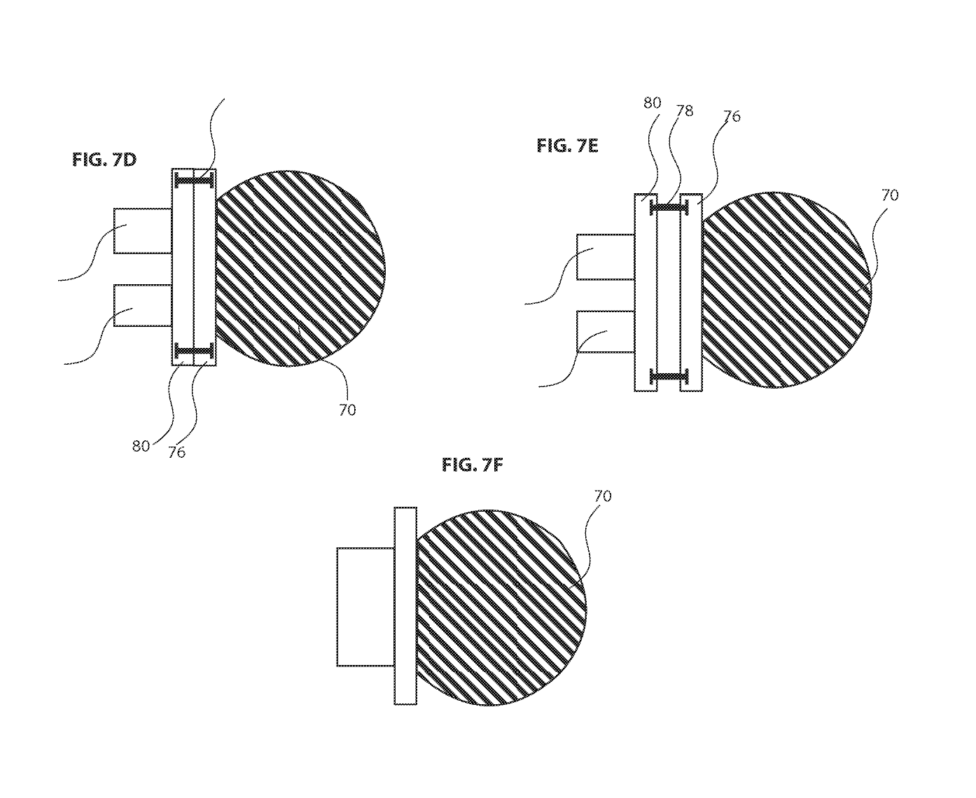

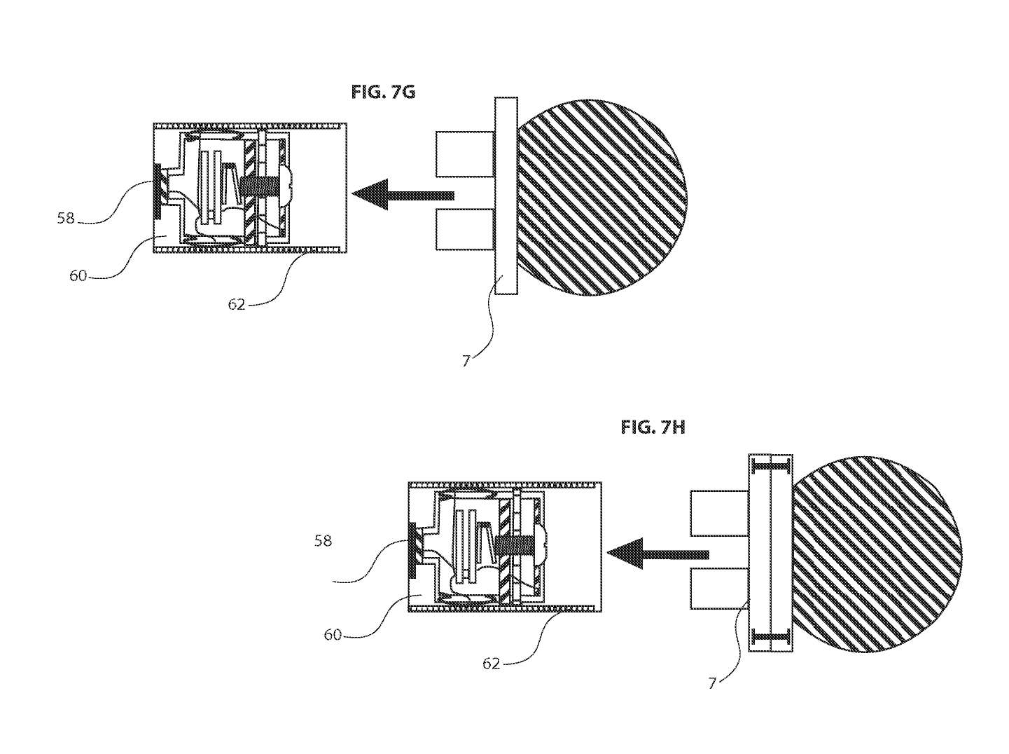

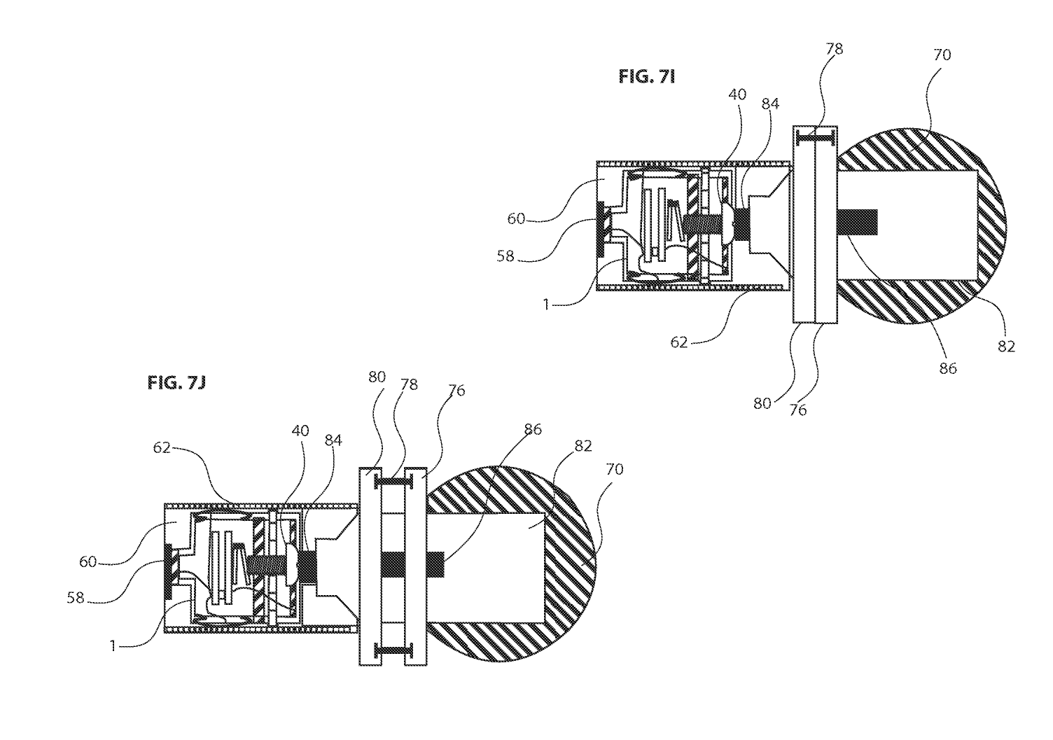

Continuing on reference to FIG. 5A, the transponder (56) has a variable potentiometer (52) actuated by the counter sink screw's (40) tip (41) to regulate the power of the radio signal to be transmitted. By regulating the power of the signal, the user can set how far will the NFC label or ID travels, helping keep the identifiable signal within the desired area. By combining the transmitting power and by deflecting the signal using the signal deflector (70) described in relation to FIG. 7A, a user can set as a desired area the driver's seat area of the vehicle so the NFC label or ID is not reachable by mobile devices located in the passenger seats.

Continuing on reference to FIG. 5A, the counter sink screw (40) also carries positive DC current fed by the positive contact pin (32) when it is connected to the positive connector of the vehicle's cigarette lighter DC connector. The charge is carried by the positive connector cable (45) connected to a cathodic rod (47) which, when there's contact between them, imparts a positive charge to the screw (40).

Referring to FIG. 2, to protect the NFC transmitter cigarette lighter adapter of unwanted removal, is important to have a cigarette lighter adapter small enough that when the cigarette lighter adapter is well inside the inner tube of a vehicle's cigarette lighter DC connector, there's no easy way to pull the unit out as the cigarette lighter adapter longitude is smaller than the longitude of the vehicle's cigarette lighter DC connector's inner tube, in the front end of the cylindrical body of the NFC transmitter cigarette lighter adapter where the LED light (38) and the counter sink screw is, there are no features to grab on to pull the unit out, as the counter sink screw (40) is all the way inside a counter sunk hole (42) preventing the user to pull the device from the counter sink screw (40). If the user cannot pull out or disconnect the device from the vehicle's cigarette lighter DC connector, that guaranties the person who installed the device to always have constant NFC label radio waves signal so the mobile device identifies when it enters a restricted area and the mobile device acts as programmed.

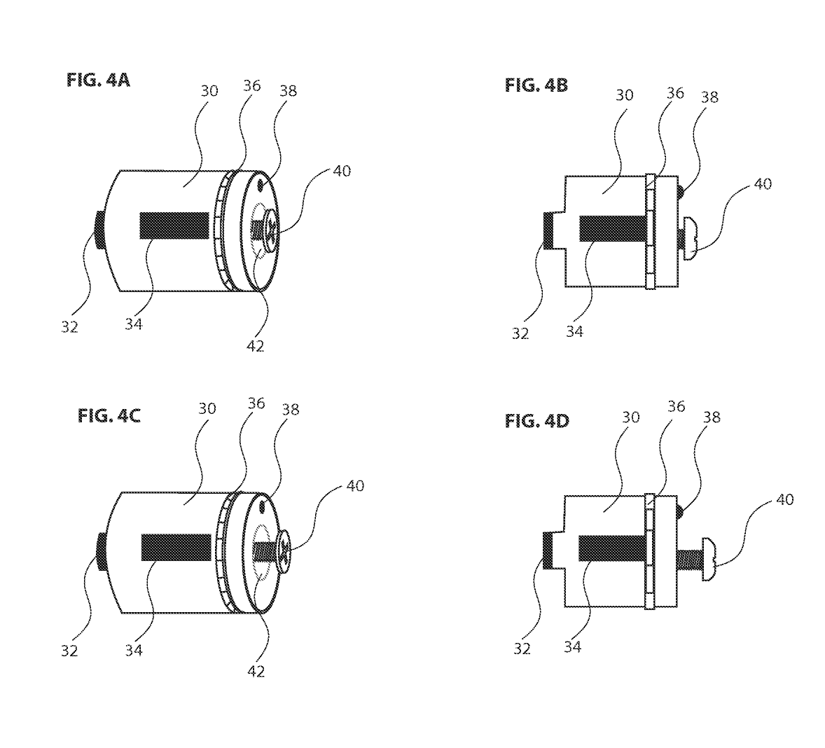

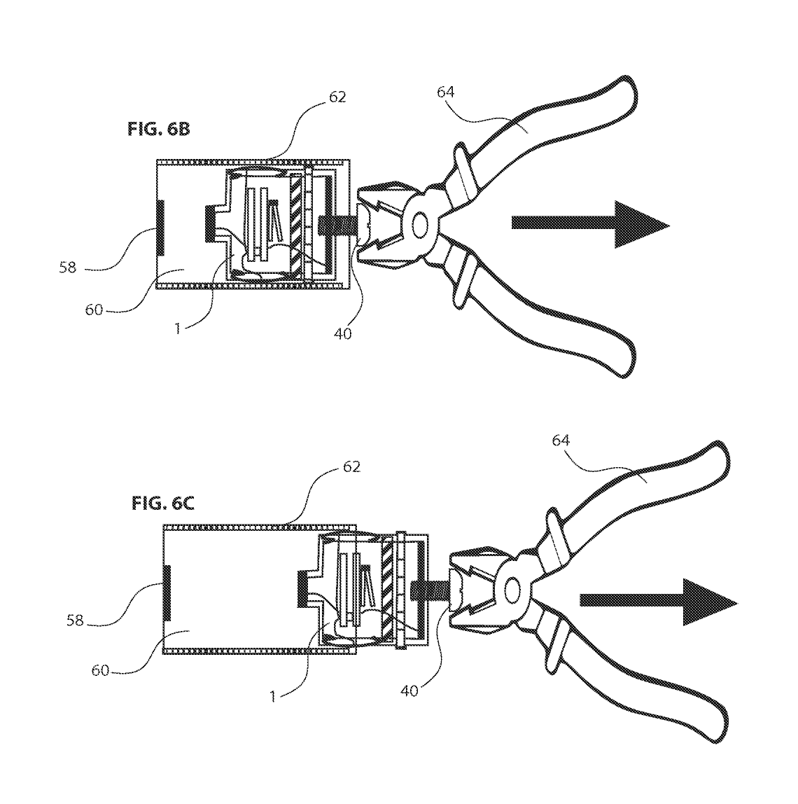

Referring to FIGS. 4A to 4D and 6A to 6C, if the user needs to remove the cigarette lighter adapter device from the vehicle's cigarette lighter DC connector's inner tube (60), the counter sink screw (40) needs to be unscrewed and pulled out from the counter sunk hole (42) using a pair of pliers (64).

Referring to FIGS. 5B, 6A, 6B and 6C, when the counter sink screw (40) is unscrewed, the connection between the screw (40) and the cathodic rod (47) is lost so the screw is no longer carrying 12 VDC electrical current, making it safe to pull the device out of the vehicle's cigarette lighter DC connector's inner tube (60) with the finger tips, using pliers (64) or some other pulling device.

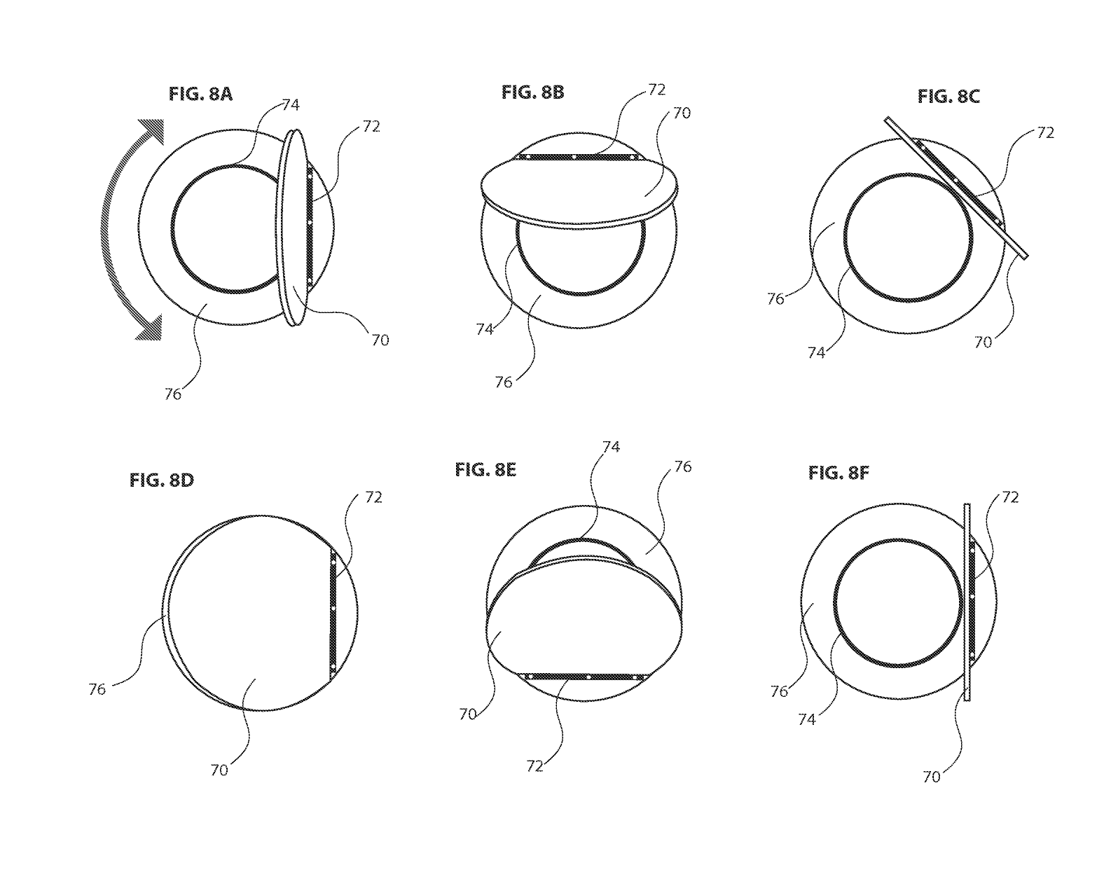

A Protractible Adjustable Signal Deflector Cap assembly generally identified by reference numeral (7) will now be described with reference to FIG. 7A through 8F.

Referring to FIGS. 7A to 7F, shows an Protractible Adjustable Signal Deflector Cap Assembly comprising a toroid (76) or a pair of toroids (80 and 76) made of a solid and part conductive material, attached on one side to a 90 degrees foldable signal deflector (70) made of radio wave deflecting material, for example a wire mesh or a metal sheet, when properly installed, the signal deflector deflects the radio waves transmitted by the NFC label Cigarette Lighter Adapter transmitter (1).

A proper installation is when the device mates the opposite end of the signal deflector to the vehicle's cigarette lighter DC connector inner tube (60) by inserting it's 2 or more legs (68) acting as male extensions that create expandable tension when inserted, affixing it securely to the vehicle's cigarette lighter DC connector's female's inner tube.

The device is removable and could be uninstalled by pulling it out and installed by pushing it in. The legs (68), made from a solid and conductive material, also work as a conduit for the negative charge of the vehicle's cigarette lighter DC connector inner tube, that connection is extended to the inner side of the inner cap toroid (80) and outer cap toroid (76). Both toroids (76, 80) are connected by a set of internal extenders (78), which allow the toroids (76 and 80) to separate or contract when needed. Both toroids' (76, 80) inner sides and the internal extenders are made of conductive material. When properly installed, the negative charge of the 12 VDC provided by the vehicle's cigarette lighter DC connector's inner tube is extended from the inner tube to the Protractible Adjustable Signal Deflector Cap assembly legs (68) then to the inside toroid (80), from there to the internal extenders (78), then to the outside toroid (76).

Referring to FIGS. 7I and 7J, when the NFC label Cigarette Lighter Adapter transmitter (1) is properly installed inside the vehicle's cigarette lighter DC connector's inner tube and the devices positive pin (32) is in contact with the vehicle's cigarette lighter DC connector's positive pin (58), the 12 VDC charge provided is extended to the counter sink screw (40), if a secondary cigarette lighter adapter (82) is inserted behind the NFC label Cigarette Lighter Adapter transmitter (1) inside the vehicle's cigarette lighter

DC connector's inner tube, that secondary cigarette lighter adapter (82) can draw positive charge from the NFC label Cigarette Lighter Adapter transmitter's (1) counter sink screw (40) and can draw negative charge from the vehicle's cigarette lighter DC connector's inner tube (62). If the antenna deflector extendible cap (7) is installed and if a secondary cigarette lighter adapter (82) needs to be installed, the signal deflector (70) has to be fully open at 90 degrees. The inner side of both toroids (76, 80) also extends the negative charge from the vehicle's cigarette lighter DC connector's inner tube's (60) negative charge(62). That negative charge is transmitted when there's contact between the toroids' (76, 80) inner side (74) and the negative side connector (86) of the secondary cigarette lighter adapter (82).

Referring to FIGS. 7G, 7H, 8A to 8F, when both, the NFC label Cigarette Lighter Adapter transmitter (1) and the Protractible Adjustable Signal Deflector Cap (7) are properly installed inside the vehicle's cigarette lighter DC connector's inner tube's (60), the radio transmissions generated by the NFC label Cigarette Lighter Adapter transmitter (1) can be deflected by the signal deflector (70) part of the Protractible Adjustable Signal Deflector Cap (7). The area within the vehicle that we want to set as a restricted zone with the NFC label transmission can be customized by a combination of two mechanical position settings, one is the capability of the signal deflector (70) to open at 90 degrees and to close up to 20 degrees, and the other is the Protractible Adjustable Signal Deflector Cap's (7) capability of rotating up to 360 degrees by twisting the cap's girth, making the connector legs (68) to also rotate inside the vehicle's cigarette lighter DC connector's inner tube (60). The ideal setting is to deflect the radio waves in such a way that the stronger signal is deflected to the driver's seat area in the vehicle. As radio waves travel at the 12 to 14 MHz range they tend to behave unpredictably, the correct configuration varies from the combination of the 2 mechanical settings previously described and a third factor, the transmission power. The best coverage is achieved when the three factors are combined: the transmitter's power, the rotation of the Protractible Adjustable Signal Deflector Cap (7) and the position of the signal deflector. FIGS. 8A to 8F represent a sample of different positions of the signal deflector (70) combined with different sample rotations of the Protractible Adjustable Signal Deflector Cap (7).

The signal deflector (70) positioning is restricted not to close more than 20 degrees to prevent complete blocking of the radio wave signals emitted by the NFC label Cigarette Lighter Adapter transmitter (1).

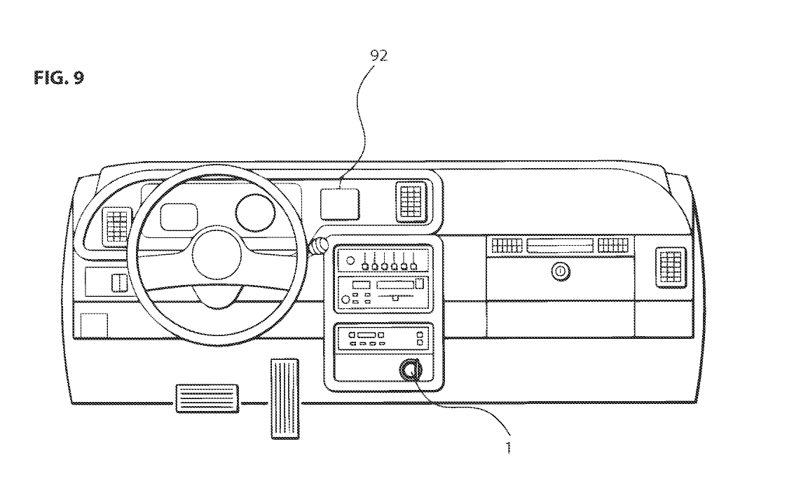

Referring to FIG. 9, a vehicle's dashboard (92) showing the position of the cigarette lighter DC connector with a NFC label Cigarette Lighter Adapter transmitter (1) installed.

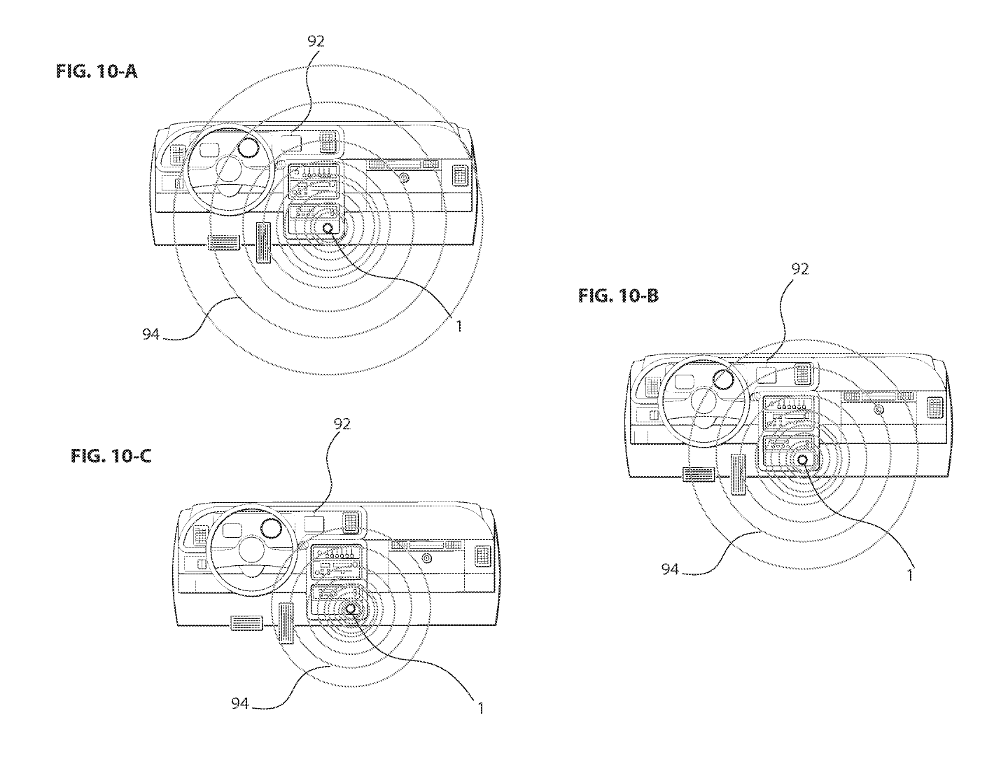

Referring to FIG. 10A, a vehicle's dashboard (92) hosting inside the vehicle's cigarette lighter DC connector a NFC label Cigarette Lighter Adapter transmitter (1) emitting a strong signal represented by undulating radio waves (94) covering a specific area inside the vehicle. This type of emission happens mostly when the transmitter is set to full power and there's no signal deflector deflecting the radio waves.

Referring to FIG. 10B, a vehicle's dashboard (92) hosting inside the vehicle's cigarette lighter DC connector a NFC label Cigarette Lighter Adapter transmitter (1) emitting a regular signal represented by undulating radio waves (94) covering a specific area inside the vehicle. This type of emission happens mostly when the transmitter is set to medium power and there's no signal deflector deflecting the radio waves.

Referring to FIG. 10C, a vehicle's dashboard (92) hosting inside the vehicle's cigarette lighter DC connector a NFC label Cigarette Lighter Adapter transmitter (1) emitting a low power signal represented by undulating radio waves (94) covering a specific area inside the vehicle. This type of emission happens mostly when the transmitter is set to low power and there's no antenna deflector deflecting the radio waves.

### Operation

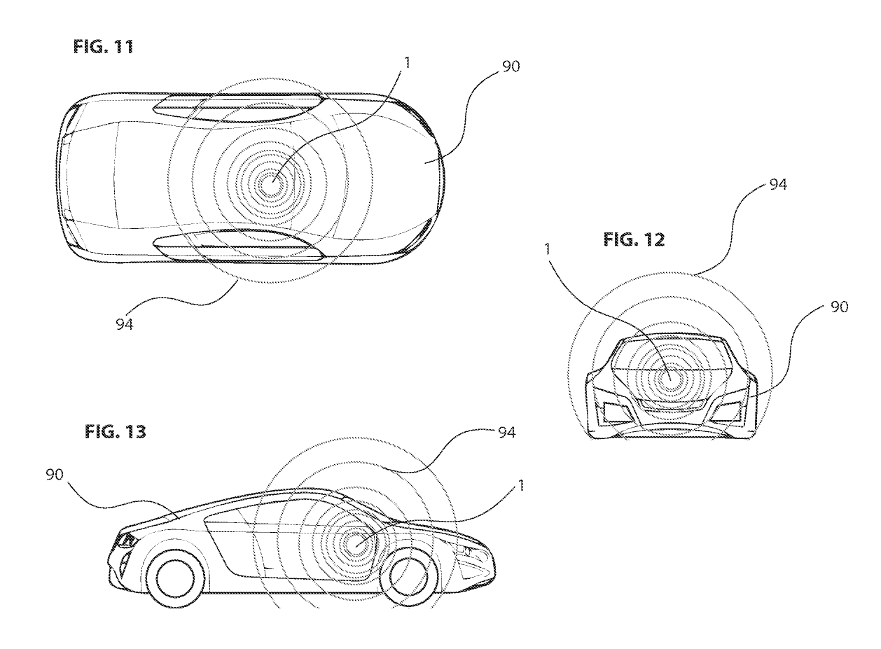

Referring to FIGS. 11 thru 13 it shows how the radio waves (94) propagate inside the vehicle (90) when the NFC label Cigarette Lighter Adapter transmitter (1) is set to full power and there's no signal deflector deflecting the radio waves.

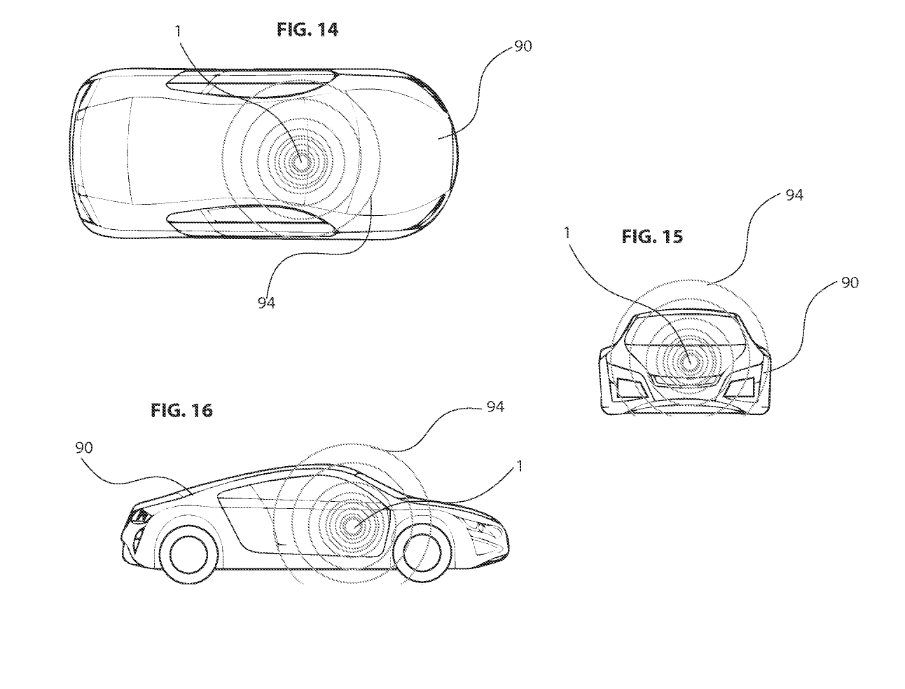

Referring to FIGS. 14 thru 16 it shows how the radio waves (94) propagate inside the vehicle (90) when the NFC label Cigarette Lighter Adapter transmitter (1) is set to regular power and there's no signal deflector deflecting the radio waves.

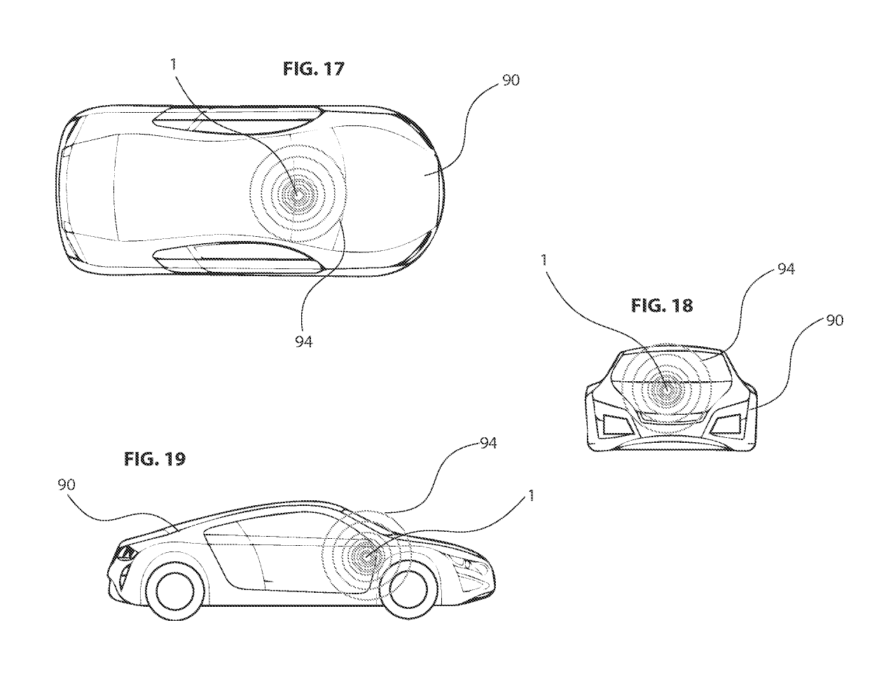

Referring to FIGS. 17 thru 19 it shows how the radio waves (94) propagate inside the vehicle (90) when the NFC label Cigarette Lighter Adapter transmitter (1) is set to low power and there's no antenna deflector deflecting the radio waves.

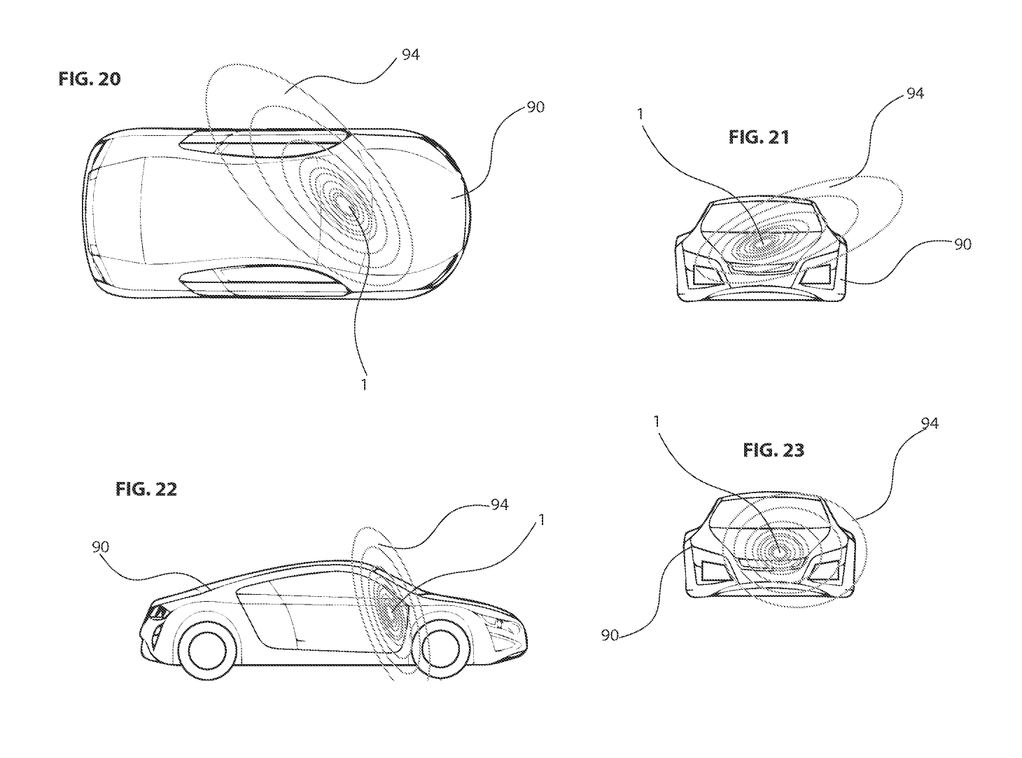

Referring to FIGS. 20 and 21 they show how the radio waves (94) propagate inside the vehicle (90) when the NFC label Cigarette Lighter Adapter transmitter (1) is set to full power and the signal deflector is deflecting the radio waves towards the driver's seat.

Referring to FIGS. 22 and 23 it shows how the radio waves (94) propagate inside the vehicle (94) when the transmitter is set to regular power and the signal deflector is almost fully closed and it's deflecting the radio waves towards the driver's seat and not letting the signals go all the way to the back passenger's seats.

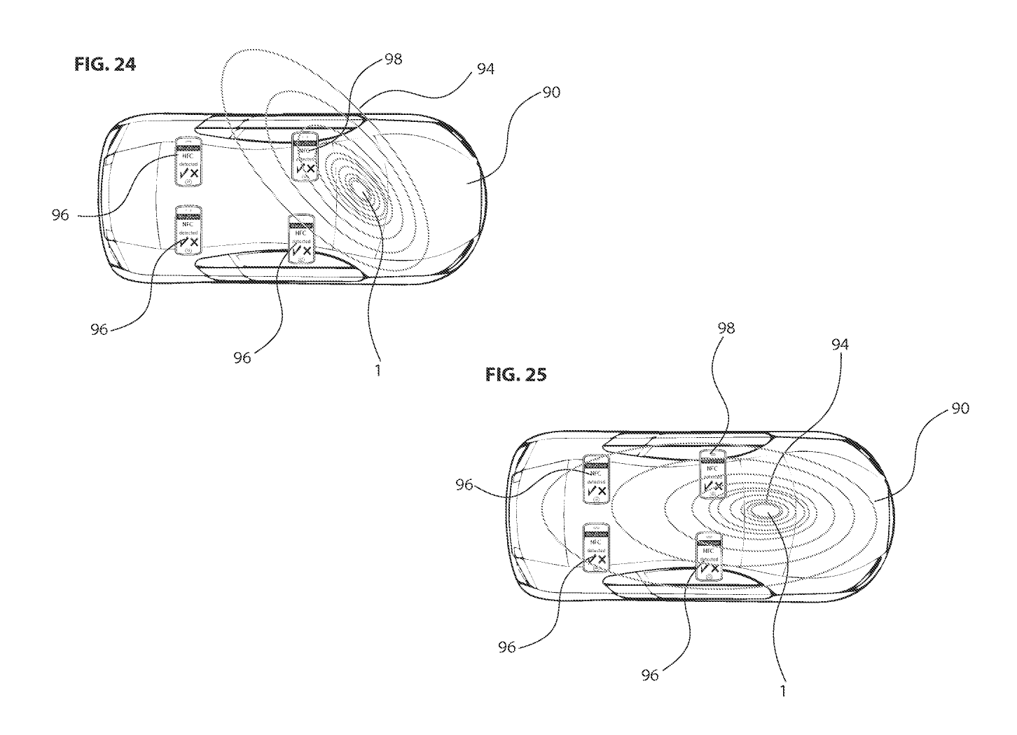

Referring to FIG. 24, a top view of the vehicle (90) is shown with a NFC label Cigarette Lighter Adapter transmitter (1) and the extendible antenna deflector cap (7) is installed inside the dashboard's cigarette lighter DC connector showing a radio signal (94) with NFC label or ID information covering a specific area inside the vehicle (90) forming an elliptical wave pointing towards the driver's seat creating a mobile device identifiable “restricted zone” where the driver's mobile device (98) such as a smart cell phone or tablet equipped with a NFC transceiver and running a compatible software detects that such mobile device is inside a restricted zone, thus changing the mobile device status from normal to “driving mode” blocking it to receive or make voice calls or text messages. Meanwhile, if there are any other mobile devices inside the vehicle, but they are operated by passengers outside the restricted zone, then the passengers' devices (96) are in an unrestricted area of the vehicle thus their mobile devices do not detect a NFC signal and even if the mobile devices are running a compatible software, it does not block the passengers' devices (96) from making or receiving voice calls or text messages.

Referring to FIG. 25 a top view of the vehicle (90) is shown with a NFC label Cigarette Lighter Adapter transmitter (1) with the extendible antenna deflector cap (7) installed inside the dashboard's cigarette lighter DC connector showing a radio signal (94) with NFC label or ID information covering a specific area inside the vehicle (90) forming an elliptical wave pointing towards the back of the vehicle creating a mobile device identifiable “restricted zone” in most of the vehicles inside area. All mobile devices (98, 96) such as a smart cell phone or tablet equipped with a NFC transceiver and running a compatible software detect that such mobile devices are inside a restricted zone, thus changing the mobile device status from normal to “driving mode” blocking the driver's and passengers' devices to receive or make voice calls or text messages. While inside a restricted zone, the passengers can execute a series of commands in their mobile devices to “select who is their driver”, identifying which device of the devices identified as inside the vehicle is the driver's device so their device, the passengers', is unblocked and can be use in normal mode and only the driver's device is the one blocked.

Referring to FIGS. 28 and 29 is a method that the software application installed in the driver's mobile device uses to systematically block any mobile device running the software application that picks up the signal sent by the NFC transmitter cigarette lighter adapter device, to do so, the system first detects that the user with the mobile device approaches the vehicle (100) if the user's position in reference to the car is outside (102) then the mobile device stays in regular operating mode (200), but if the user's device position in reference to the car (101) is inside (103), it then verifies if it is within the radio waves range (104), if it is not within the range (106) then the device stays in regular operating mode (200), but if it is within the radio waves (104) for a predetermined amount of time (108) and the mobile device decodes the ID label sent by the NFC transmitter cigarette lighter adaptor, it enters into “driving mode” blocking the driver's and passengers' devices running the software to receive or make voice calls or text messages. If it is the passengers device (111) the one that is blocked and since the idea behind this invention is to help the driver not to distract from driving, the passenger can opt out of the blocking by overriding the method (112), in order to override the method, the passenger must choose from a list of mobile devices displayed in the passenger's mobile device which of the other devices identified as inside the same coverage area inside the vehicle is the driver (114), the passenger must select who is his or her driver (118) and such mobile device is then tagged as a driver's mobile device (119). Once tagged as a “driver” that driver's mobile device cannot be selected to be identified as a passenger's mobile device (120). Once the sequence to select who is your driver is completed by the passenger (121) the passenger's device is back in normal operating mode (122) capable of making and receiving voice calls and text messages (200). If a passenger is not able to identify who is his or her driver, the passenger can also opt out of the blocking by performing a passenger's mode sequence to override the blocking also known as driver's mode (123). If the sequence is correct (124) then the mobile device is set back to normal mode (200).

If the device is the driver's mobile device (110) then, the manual text input and outgoing calls without a hands free device or Bluetooth communication are blocked (130). Based on the Global Positioning System built in to the mobile device, the software can identify if the vehicle where the mobile device is detected is moving or not. If the user of the driver's mobile device needs to override the blocking (131) on the driver's mobile device, it may be because the user is one of the passengers and not the driver of the vehicle himself, if so, then that passenger needs to perform a passenger's overriding sequence on the driver's mobile device (133), such override will only work for a predetermined amount of time and is not permanent (135), when the override sequence time is over (137), the manual text input and outgoing calls without a hands free device or Bluetooth communication is blocked (130).

If the driver needs to override the blocking (131) on the driver's mobile device when the vehicle is not moving and the manual override is active, the driver may select to send text messages, place outgoing calls and operate the mobile device as in regular mode for a predetermined amount of time (140), when that time is over (142), the manual override to place calls or text is not allowed. The driver needs to stop the vehicle for manual override to work (144). In all cases, if the vehicle is not moving the manual override time can be extended.

If the driver needs to override the blocking because it is an emergency (150) and the vehicle is either moving or not (134) a manual override can be performed to call 911 or a predetermined emergency number (152).

Once the initial setup of the driver's mobile device is done, the mobile device is set to “driving mode” and the system goes in to a “Stand-by mode” (300).

When a call or text comes in, the blocking level type selected on the mobile device will determine how the mobile device should behave as follows:

When a text comes in (302) and the vehicle is equipped with a text to speech message Bluetooth (310) and the driver has selected that the messages should be read out loud (312), then the messages are answered by the car's Bluetooth entertainment system (314).

When a text message comes in (302) and the vehicle is equipped with a text to speech message Bluetooth (310) but the driver does not want the messages to be read out loud (313) and the driver has selected to have automatic replied enabled (322), then the mobile device sends a reply email saying the device is in driving mode and text messages will be shown to the driver once driving mode is off. No alert sounds on the device (324) unless the alert override is on (328) and the conditions to override by accumulation of incoming messages exceeds the pre-programmed amount set by the installer of the device (330), in such case, an alert override sound plays to alert the driver that it may be time to take a brake from driving, stop the vehicle and reply to those text messages (332).

When a text message comes in (302) when the device is inside a vehicle that is not equipped with a text to speech message Bluetooth device (320) and the driver wants the sender of the message to know he's driving (321) and the automatic reply feature is enabled (323), then the mobile device sends a reply email or text alerting the sender that the device is in driving mode and text messages will be shown to the driver once driving mode is off. No alert sounds on the device (324).

When an incoming call comes in (304) and the vehicle is equipped with hands free Bluetooth (351) and the driver wants incoming calls to be answered in speaker mode (353), then, the incoming calls are answered by the car's Bluetooth entertainment system (355).

When an incoming call comes in to the mobile device (304) and the vehicle is not equipped with a hands free Bluetooth device (350) and the user has connected headphone or auxiliary cables to the device (360) when automatic answer is enabled (362), then, the device answers all calls via the headphones or auxiliary cables (364) in a operation commonly referred as hands free answering.

When an incoming call comes in to the mobile device (304) and the vehicle is not equipped with a hands free device (350) and the user has not connected the headphones in (361), then the call goes to voicemail, no alert sounds on the device (356), unless alert override is on (372) and the number of incoming calls has exceeded the amount predetermined by the installer or the driver (374), then an alert override sound plays to alert the driver that it may be time to take a brake, stop the vehicle and answer or return the calls (375).

Once the mobile device is out of reach of the radio signal sent by the NFC transmitter cigarette lighter adapter installed inside the vehicle for more time than the predetermined time set by the installer, the device goes back to regular mode (340). If there were any unanswered calls (376) or unanswered text messages (344) a reminder is displayed in the device's screen (380)

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1. An electronic device comprising:
A first component of a cylindrical body, it's diameter smaller than 21 mm and it's longitude smaller than the standard depth of a vehicle's cigarette lighter DC connector's inner tube.

2. The device described in claim 1 with a built in adjustable power NFC label transmitter with it's external potentiometers' counter sink screw head inside a counter sunk hole at the flat front end of the device.

3. The potentiometer's counter sink screw from claim 2 that also serves as a positive charge conductor extender from the vehicle's cigarette lighter DC connector's positive pin.

4. The device described in claim 1 with the flat front end flushed and any raised components small enough so there are no available pieces to pull from to remove it without tools when installed inside a standard vehicle's cigarette lighter DC connector.

5. A second component in the form of a cap that on the inside end has 2 or more semi circular elongations that fit inside the outer end of a standard vehicle's cigarette lighter DC receptacle and create tension to withhold it and on the opposite end has a hinged adjustable disc signal deflector.

6. The device described in claim 5 that can rotate 360 degrees when fitted inside a vehicle's cigarette lighter DC connector.

7. The device described in claim 5 that has one or more conductive toroids that carries the negative charge draw from the cigarette lighter adapter's inner tube.

8. A method that systematically blocks the driver's mobile device capabilities to receive and generate text messages or voice calls when such mobile device is running a software application that works in conjunction with the device described in claim 2 when installed inside a vehicle that identifies who is the driver and passengers of said vehicle by wirelessly reading the NFC id label transmitted by said device and by polling any available passengers.

9. the method described in claim 8 that can be overridden by the driver if the mobile device accelerometer detects the vehicle is not moving and the driver performs a series of functions to confirm the override.

10. the method described in claim 8 that can be overridden by a passenger of that vehicle even if the mobile device's accelerometer and GPS function detects the vehicle is moving when the passenger confirms is the passenger and not the driver who is using the device.

11. the method described in claim 8 that can be overridden by the accumulation of incoming text messages or voice calls, when that amount exceeds the predetermined number configured.
